(19) United States
(12) Patent Application Publication
(10) Pub. No.: US 2024/0017454 A1
(43) Pub. Date: Jan. 18, 2024

(54) METHOD FOR MANUFACTURING ANTIBACTERIAL COPPER NANOFIBER BY INJECTION MOLDING

(71) Applicant: QUANN CHENG INTERNATIONAL CO., LTD., Pingtung City (TW)

(72) Inventor: Hsing Hsun LEE, Pingtung City (TW)

(21) Appl. No.: 18/372,624

(22) Filed: Sep. 25, 2023

Related U.S. Application Data
(63) Continuation-in-part of application No. 17/378,071, filed on Jul. 16, 2021.

(30) Foreign Application Priority Data
Sep. 29, 2020 (TW) 109133928

(51) Int. Cl. B29C 45/00; B29B 7/00

(52) U.S. Cl. CPC B29C 45/0013; B29B 7/002; B29C 2045/0094; B29K 2105/0011

(57) ABSTRACT

A method for manufacturing an antibacterial copper nanofiber by injection molding includes the following steps: raw material mixing operation: mixing dry copper nanopowder having an averaged particle size of not more than 48 nm with a fiber raw material to form a mixed raw material; and injection molding operation, including plasticization, filling, pressurization, cooling, ejection, and product injection. Finally, an antibacterial copper nanofiber injection product is obtained. Or in the raw material mixing operation, after mixing a dry copper nanopowder having an averaged particle size of not more than 48 nm with a fiber raw material to form a mixed raw material, mixing and granulating operation can be added, including heating, blending, extruding and granulating the mixed raw material through a mixer, and then melting to form a plurality of antibacterial copper nano-masterbatches; and then injection molding operation is performed to obtain an antibacterial copper nanofiber injection product.

### BACKGROUND

### Technical Field

The present invention relates to a method for manufacturing antibacterial fiber by injection molding, and in particular to a method for manufacturing an antibacterial copper nanofiber product by adding nanoscale copper powder to a polymer to form a raw material and then injection molding.

### Related Art

Nanomaterials refer to tiny materials whose size is 1-100 nm (1 nm is 10⁹ n). In a broad sense, nanomaterials refer to all materials having at least one dimension at the nanoscale level in a three-dimensional space or composed of matter at the nanoscale level as basic structural units.

Man-made fiber injection products can be applied to items in direct contact with people or pets, such as masks, gloves, 3C housings and other products. However, these man-made fiber injection products being in direct contact with people or pets are also the most likely to be contaminated by bacteria and breed pathogens, which is harmful to the users. Therefore, such products with antibacterial effects are in demand.

Generally, the so-called “antibacterial” mainly refers to controlling the parasitism and increase of microorganisms, inhibiting the reproduction of bacteria which are harmful to the human body and preventing the production of bacteria in advance. Fibers and textiles are likely to absorb sweat and human body fluids or skin excreta, and such excreta are the best breeding place for bacteria. Most of bacteria use the excreta as nourishment to grow and reproduce, and also decompose to generate many unpleasant smells and gases.

According to a new study published by the World Health Organization at the First International Conference on Prevention and Infection Control in Switzerland, use of antibacterial copper surfaces in hospitals can reduce the chance of Healthcare-Associated infection (HAI) by up to 40%, and can effectively kill 97% of bacteria and many viruses and fungal pathogens.

Copper is a life element found in the human body, so cupric ion compounds can be dissolved, and also undergo normal metabolisms and excretions. Therefore, copper is non-irritating and not allergic to human skin, and is safe for human health.

In 2009, Professor Bill Keevil from the University of Southampton in the United Kingdom published a research report, pointing out that copper can inhibit the reproduction of A H1N1 influenza virus. After 6 hours, there was almost no surviving influenza virus on the copper surface, while after 24 hours, there were still 500,000 viruses alive on the stainless steel surface. In the same year, a test conducted by the US Environmental Protection Agency (EPA) showed that at room temperature, copper alloys can kill 99.9% of the superbug MRSA on their surface within two hours.

As a new antibacterial product, an antibacterial copper nanofiber injection product can prevent diseases from spreading, eliminate odors and revitalize the skin. As early as 2008, the Natural Resources Defense Council (NRDC), a US-based environmental protection agency, registered and approved five types of copper alloys for antibacterial materials. These copper alloys can kill 99% of bacteria on the surface of objects within 2 hours.

### SUMMARY

An objective of the present invention is to provide a method for manufacturing an antibacterial copper nanofiber by injection molding, by uniformly mixing nano-sized copper particles with a polymer fiber raw material and then injection molding to obtain an antibacterial copper nanofiber injection product.

In order to achieve the above objective, the present invention provides a method for manufacturing an antibacterial copper nanofiber by injection molding, including: raw material mixing copper ion operation and injection molding operation, where the raw material mixing copper ion operation includes: mixing dry copper nanopowder and graphene powder both having an averaged particle size of not more than 48 nm with a fiber raw material to form a mixed raw material, a weight percentage range of the copper nanopowder added to the fiber raw material being 20% to 24%, and a weight percentage range of the graphene powder added to the fiber raw material being 6% to 9%; and the injection molding operation includes: plasticization: loading a hopper of an injection machine with the mixed raw material, transferring the mixed raw material from the hopper into a barrel, extruding the mixed raw material with a screw in the barrel to turn the mixed raw material into a molten state by frictional heating, and maintaining the melting temperature of the mixed raw material by using a heater;
filling: pushing the screw to pour the molten mixed raw material into a mold cavity in a closed state through a discharge port of the barrel;
pressurization: after filling the mold cavity with the molten mixed raw material, continuing to apply high pressure and adding the mixed raw material until a pouring gate is solidified;
cooling: cooling the mixed raw material in the mold cavity;
ejection: opening the mold and ejecting the cooled and formed mixed raw material out of the mold cavity; and
product injection: removing a runner system and waste materials to produce an antibacterial copper nanofiber injection product.

In some implementation aspects, the fiber raw material includes thermoplastic polyurethane (TPU), thermoplastic rubber (TPR), polyethylene (PE), polypropylene (PP), polyethylene terephthalate (PET), polyamide (PA), polybutylene terephthalate (PBT), ethylene-vinyl acetate copolymer (EVA) or nylon.

In some implementation aspects, during the step of raw material mixing operation, a toning colorant can be further added.

The present invention is characterized in that by mixing the copper powder having an averaged particle size of not more than 48 nm with the fiber raw material and then injection molding, the adhesion of the copper element can be improved in the subsequently made injection product, thereby improving the antibacterial sustainability of the injection molded product. In the present invention, the nanoscale copper powder is mixed with the fiber so that the fiber material itself evenly carries the antibacterial copper nanomaterial. Different from a traditional process of soaking the surface of the fiber with an antibacterial agent, the present invention has a long-acting function of inhibiting the reproduction and growth of bacteria. In one embodiment, the present invention can directly perform an injection process after mixing the copper nanopowder with the fiber raw material without preparing copper masterbatches. The fluidity of the raw material is driven by the screw to achieve a mixing effect, and the finished product usually does not require additional processing, thereby simplifying the process.

### BRIEF DESCRIPTION OF THE DRAWINGS

FIG. 1 is a flow chart of a method for manufacturing an antibacterial copper nanofiber by injection molding according to an embodiment of the present invention.

FIG. 2 is a flow chart of a method for manufacturing an antibacterial copper nanofiber by injection molding according to another embodiment of the present invention.

FIG. 3 to FIG. 6 are schematic diagrams of the equipment flow in FIG. 1.

### DETAILED DESCRIPTION

Embodiments of the present invention are described in detail below with reference to the accompanying drawings, the accompanying drawings are mainly simplified schematic diagrams, and only exemplify the basic structure of the present invention schematically. Therefore, only the components related to the present invention are shown in the drawings, and are not drawn according to the quantity, shape, and size of the components during actual implementation. During actual implementation, the specification of size of the components is actually an optional design, and the layout of the components may be more complicated.

In addition, the drawings may not be necessarily drawn to scale. For example, sizes of some components in the drawings may be increased or reduced, to illustrate improvements on understanding of various implementations. Similarly, to discuss some of the implementations, some components and/or operations may be divided into different blocks or combined into a single block. In addition, although specific embodiments are exemplarily shown in the drawings and described below in detail, any modification, equivalent, or replacement that can be figured out by a person skilled in the art shall fall within the scope of the appended claims.

### Embodiment I

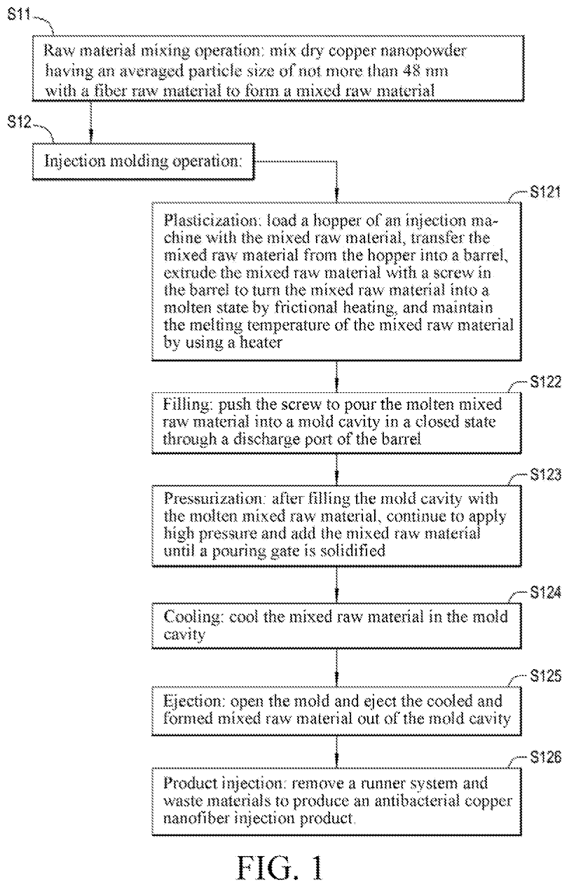

Refer to FIG. 1 and FIG. 3 to FIG. 6, which are a flow chart of and a schematic diagram of equipment flow of a method for manufacturing an antibacterial copper nanofiber by injection molding according to an embodiment of the present invention. The steps of the present embodiment include: raw material mixing operation (step S11) and injection molding operation (step S12).

The raw material mixing operation (step S11) is to mix dry copper nanopowder 1a and graphene powder 1b both having an averaged particle size of not more than 48 nm with a fiber raw material 2 to form a mixed raw material.

The injection molding operation (step S12) includes the following steps: plasticization (step S121), filling (step S122), pressurization (step S123), cooling (step S124), ejection (step S125), and product injection (step S126).

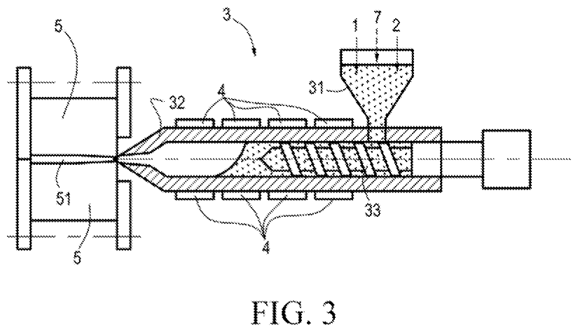

The plasticization step (step S121) is to load a hopper 31 of an injection machine 3 with the mixed raw material, transfer the mixed raw material from the hopper 31 into a barrel 32, extrude the mixed raw material with a screw 33 in the barrel 32 to turn the mixed raw material into a molten state by frictional heating, and maintain the melting temperature of the mixed raw material by using a heater 4, as shown in FIG. 3.

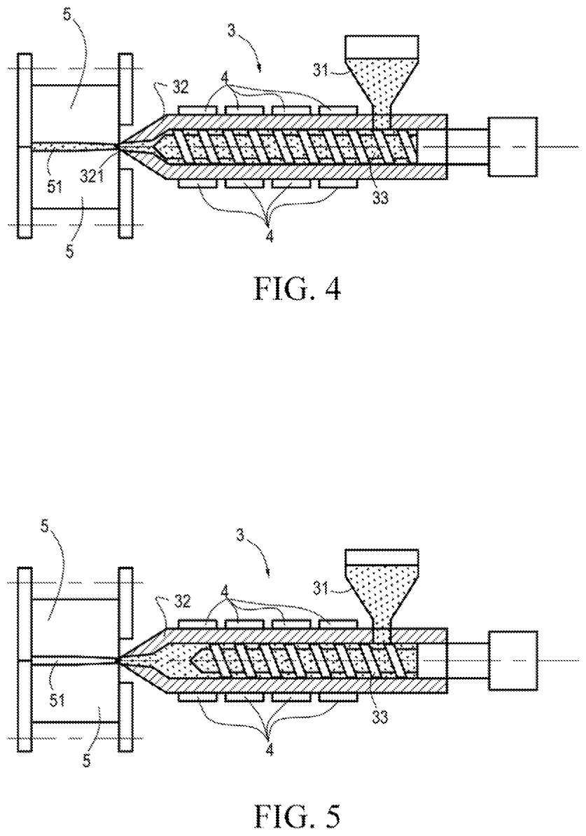

The filling step (step S122) is to push the screw 33 to pour the molten mixed raw material into a mold cavity of a mold in a closed state through a discharge port 321 of the barrel 32, as shown in FIG. 4-FIG. 5.

The pressurization step (step S123) is to, after filling the mold cavity with the molten mixed raw material, continue to apply high pressure and to add the mixed raw material until a pouring gate 6 is solidified.

The cooling step (step S124) is to cool the mixed raw material in the mold cavity 51.

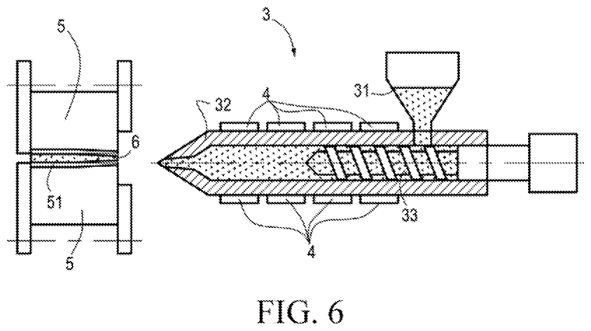

The ejection step (step S125) is to open the mold 5 and eject the cooled and formed mixed raw material out of the mold cavity 51, as shown in FIG. 6.

The product injection step (step S126) is to remove a runner system and waste materials to produce an antibacterial copper nanofiber injection product P.

### Embodiment II

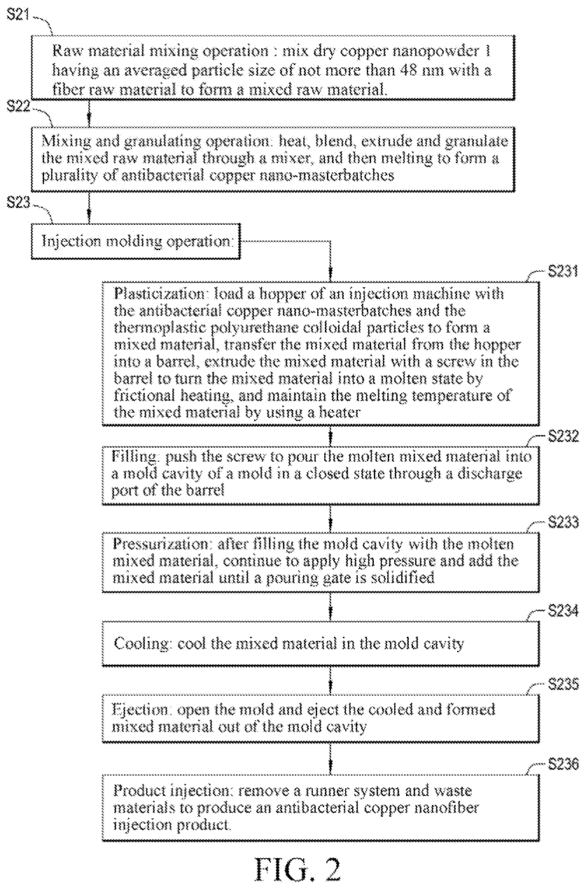

Refer to FIG. 2, which is a flow chart of a method for manufacturing an antibacterial copper nanofiber by injection molding according to an embodiment of the present invention. The steps of the present embodiment include: raw material mixing operation (step S21), mixing and granulating operation (step S22): heating, blending, extruding and granulating the mixed raw material through a mixer, and then melting to form a plurality of antibacterial copper nano-masterbatches; and injection molding operation (step S23), including:
plasticization step (step S231): loading a hopper of an injection machine with the antibacterial copper nano-masterbatches and a plurality of thermoplastic polyurethane colloidal particles to form a mixed material, transferring the mixed material from the hopper into a barrel, extruding the mixed material with a screw in the barrel to turn the mixed material into a molten state by frictional heating, and maintaining the melting temperature of the mixed material by using a heater;
filling step (step S232): pushing the screw to pour the molten mixed material into a mold cavity of a mold in a closed state through a discharge port of the barrel;
pressurization step (step S233): after filling the mold cavity with the molten mixed material, continuing to apply high pressure and adding the mixed material until a pouring gate is solidified;
cooling step (step S234): cooling the mixed material in the mold cavity;
ejection step (step S235): opening the mold and ejecting the cooled and formed mixed material out of the mold cavity; and
product injection step (step S236): removing a runner system and waste materials to produce an antibacterial copper nanofiber injection product.

In some embodiments, the copper nanopowder 1a is mixed with the fiber raw material 2 in a weight percentage range of 0.1%-30%.

In some embodiments, preferably, the copper nanopowder 1a is added to the fiber raw material 2 in a weight percentage range of 20%-24%.

In some embodiments, the graphene powder 1b is mixed with the raw fiber material 2 in a weight percentage range of 6% to 9%. The graphene powder 1b offers the effects including improving heat resistance of the antibacterial copper nanofiber injection product, increasing far infrared energy and increasing tensile strength.

It is worth mentioning that after the graphene powder 1b is added, the antibacterial copper nanofiber injection product is tested by Intertek Testing Services Taiwan, and it is known from its Taiwan notarial test report (report No.: TWNT01893033) that the radial and zonal tensile forces of the antibacterial copper nanofiber injection product reach 114.0 kg and 108.3 kg respectively. In addition, the average emission rate of the antibacterial copper nanofiber injection product reaches 0.892 for the far infrared with a wavelength of 8-13 m.

In some embodiments, the fiber raw material 2 includes thermoplastic polyurethane (TPU), thermoplastic rubber (TPR), polyethylene (PE), polypropylene (PP), polyethylene terephthalate (PET), polyamide (PA), polybutylene terephthalate (PBT), ethylene-vinyl acetate copolymer (EVA) or nylon.

In some embodiments, during the step of raw material mixing operation, a toning colorant 7 can be further added.

What is claimed is:

1. A method for manufacturing an antibacterial copper nanofiber by injection molding, comprising the following steps:
raw material mixing operation: mixing dry copper nanopowder and graphene powder both and graphene powder both having an averaged particle size of not more than 48 nm with a fiber raw material to form a mixed raw material, a weight percentage range of the copper nanopowder added to the fiber raw material being 20% to 24%, and a weight percentage range of the graphene powder added to the fiber raw material being 6% to 9%; and
injection molding operation, comprising:
plasticization: loading a hopper of an injection machine with the mixed raw material, transferring the mixed raw material from the hopper into a barrel, extruding the mixed raw material with a screw in the barrel to turn the mixed raw material into a molten state by frictional heating, and maintaining the melting temperature of the mixed raw material by using a heater;
filling: pushing the screw to pour the molten mixed raw material into a mold cavity of a mold in a closed state through a discharge port of the barrel;
pressurization: after filling the mold cavity with the molten mixed raw material, continuing to apply high pressure and adding the mixed raw material until a pouring gate is solidified;
cooling: cooling the mixed raw material in the mold cavity;
ejection: opening the mold and ejecting the cooled and formed mixed raw material out of the mold cavity; and
product injection: removing a runner system and waste materials to produce an antibacterial copper nanofiber injection product.

2. A method for manufacturing an antibacterial copper nanofiber by injection molding, comprising the following steps:
raw material mixing operation: mixing dry copper nanopowder having an averaged particle size of not more than 48 nm with a fiber raw material to form a mixed raw material;
mixing and granulating operation: heating, blending, extruding and granulating the mixed raw material through a mixer, and then melting to form a plurality of antibacterial copper nano-masterbatches; and
injection molding operation, comprising:
plasticization: loading a hopper of an injection machine with the antibacterial copper nano-masterbatches and a plurality of thermoplastic polyurethane colloidal particles to form a mixed material, transferring the mixed material from the hopper into a barrel, extruding the mixed material with a screw in the barrel to turn the mixed material into a molten state by frictional heating, and maintaining the melting temperature of the mixed material by using a heater;
filling: pushing the screw to pour the molten mixed material into a mold cavity of a mold in a closed state through a discharge port of the barrel;
pressurization: after filling the mold cavity with the molten mixed material, continuing to apply high pressure and adding the mixed material until a pouring gate is solidified;
cooling: cooling the mixed material in the mold cavity;
ejection: opening the mold and ejecting the cooled and formed mixed material out of the mold cavity; and
product injection: removing a runner system and waste materials to produce an antibacterial copper nanofiber injection product.

3. The method for manufacturing an antibacterial copper nanofiber by injection molding of claim 1, wherein the fiber raw material comprises thermoplastic polyurethane (TPU), thermoplastic rubber (TPR), polyethylene (PE), polypropylene (PP), polyethylene terephthalate (PET), polyamide (PA), polybutylene terephthalate (PBT), ethylene-vinyl acetate copolymer (EVA) or nylon.

4. The method for manufacturing an antibacterial copper nanofiber by injection molding of claim 1, wherein during the step of raw material mixing operation, a toning colorant can be further added.
